(19) United States
(12) Patent Application Publication
(10) Pub. No.: US 2026/0319393 A1
(43) Pub. Date: Oct. 15, 2026

(54) IMAGE FORMING APPARATUS

(71) Applicant: CANON KABUSHIKI KAISHA, Tokyo (JP)

(72) Inventors: SHINICHI AGATA, Shizuoka (JP); SEIICHI SHINOHARA, Shizuoka (JP); HISASHI TANIGUCHI, Shizuoka (JP)

(21) Appl. No.: 19/465,427

(22) Filed: Jan. 30, 2026

(30) Foreign Application Priority Data
Mar. 3, 2025 (JP) 2025-033264

(51) Int. Cl. G03G 15/01; G03G 15/16; G03G 21/00

(52) U.S. Cl. CPC G03G 15/0131; G03G 15/0126; G03G 15/0189; G03G 15/161; G03G 21/0005

(57) ABSTRACT

An image forming apparatus includes first and second image carriers, an intermediate transfer belt receiving toner images from both carriers by primary transfer, a secondary transfer member for transferring the images to a transfer material, a belt cleaning member downstream of the secondary transfer nip, and a drum cleaning member for the first image carrier. The first image carrier has a smaller surface roughness than the second image carrier at their contact areas with the belt. The first image carrier also has a higher absolute dark portion potential than the second image carrier. This configuration allows residual toner on the belt to reverse-transfer to the smoother first image carrier where it is more effectively cleaned, achieving both low driving torque and reliable cleaning performance.

### BACKGROUND

### Field of the Technology

The present disclosure relates to an image forming apparatus.

### Description of the Related Art

As an image forming apparatus, there is an apparatus that forms an image on a recording material (recording medium) using an electrophotographic image forming method. Examples of the image forming apparatus include a copying machine, a printer (laser beam printer, LED printer, or the like), a facsimile machine, a word processor, and a multifunction peripheral (multifunction printer) thereof.

In an electrophotographic color image forming apparatus, there has been conventionally known a configuration using an intermediate transfer method in which toner images are sequentially transferred from an image forming unit of each color to an intermediate transfer member, and the toner images are collectively transferred from the intermediate transfer member to a transfer material.

In such an image forming apparatus, each of the image forming units of the respective colors includes a drum-shaped photoreceptor (hereinafter, referred to as a photosensitive drum) as an image carrier. As the intermediate transfer member, an intermediate transfer belt formed of an endless belt is widely used. The toner image formed on the photosensitive drum of each image forming unit is primarily transferred to the intermediate transfer belt by applying a voltage from a primary transfer power supply to a primary transfer member provided to face the photosensitive drum via the intermediate transfer belt.

A toner charged in a polarity opposite to the regular polarity or a toner having a low charge amount may remain on the photoreceptor without being transferred in a primary transfer step. In order to remove the residual toner, a cleaning method is used in which a cleaning member is brought into contact with the photosensitive drum to remove the residual toner. From the viewpoint of simplicity of configuration and removal capability, blade cleaning in which a cleaning blade made of an elastic body is brought into contact with the photosensitive drum in a counter direction with respect to a rotation direction of the photosensitive drum is widely known.

On the other hand, the toner images of the respective colors primarily transferred to the intermediate transfer belt are secondarily transferred collectively from the intermediate transfer belt to a transfer material such as paper or an OHP sheet by applying a voltage from the secondary transfer power supply to the secondary transfer member in a secondary transfer unit. In a secondary transfer step, a toner (transfer residual toner) may remain on the intermediate transfer belt. As a cleaning method for removing the transfer residual toner, the blade cleaning is widely used in which contact is made in a direction (counter direction) opposing a moving direction of the intermediate transfer belt.

In the two counter type blade cleaning, the cleaning blade is strongly brought into contact with and rubbed against the photosensitive drum and the intermediate transfer belt. Therefore, a drive torque of the photosensitive drum and a drive torque of the intermediate transfer belt occupy most of a drive torque of the image forming apparatus, and affect a motor size.

For example, Japanese Patent Laid-Open 2020-079905 and Japanese Patent Laid-Open 2019-191511 disclose reduction of a drive torque in blade cleaning for reduction of power consumption by reduction of a drive torque of an image forming apparatus and miniaturization by motor size reduction. Japanese Patent Laid-Open 2020-079905 discloses a technique for controlling surface roughness of a photosensitive drum. Japanese Patent Laid-Open 2019-191511 discloses a technique for controlling surface roughness of an intermediate transfer belt. These techniques reduce a contact area between a cleaning blade and the photosensitive drum and a contact area of the intermediate transfer belt, and reduce a friction coefficient to reduce the drive torque.

### SUMMARY

The present disclosure provides an image forming apparatus comprising: a first image carrier; a second image carrier; an intermediate transfer belt that is an endless belt configured to be rotatable while coming into contact with the first image carrier and the second image carrier, wherein a first toner image on the first image carrier and a second toner image on the second image carrier are primarily transferred onto the intermediate transfer belt; a secondary transfer member that forms a secondary transfer portion with the intermediate transfer belt in order to secondarily transfer the first toner image and the second toner image primarily transferred to the intermediate transfer belt to a transfer material; a secondary cleaning member that is provided on a downstream side of the secondary transfer portion in a moving direction of the intermediate transfer belt, comes into contact with the intermediate transfer belt, and cleans toner remaining without being secondarily transferred to the transfer material; and a primary cleaning member that comes into contact with the first image carrier and cleans residual toner after primary transfer, wherein an average roughness of a surface of the first image carrier in contact with the intermediate transfer belt is smaller than an average roughness of a surface of the second image carrier in contact with the intermediate transfer belt, and an absolute value of a dark portion potential of the first image carrier is larger than an absolute value of a dark portion potential of the second image carrier.

Features of the present disclosure will become apparent from the following description of embodiments with reference to the attached drawings. The following description of embodiments is described by way of example.

### BRIEF DESCRIPTION OF THE DRAWINGS

FIG. 1A is a schematic sectional view of an image forming apparatus according to the present embodiment.

FIG. 1B is a sectional view of a process cartridge of the image forming apparatus according to the present embodiment.

FIG. 2 is a schematic block diagram illustrating a control mode of the image forming apparatus according to the present embodiment.

FIG. 3 is a schematic view of a polishing apparatus for polishing a surface of a photosensitive drum according to the present embodiment.

### DESCRIPTION OF THE EMBODIMENTS

Hereinafter, embodiments of the present disclosure will be exemplarily described in detail based on examples with reference to the drawings. However, the dimensions, materials, shapes, relative arrangements, and the like of the components described in these embodiments should be appropriately changed according to the configuration of the apparatus to which the disclosure is applied and various conditions.

That is, the scope of the present disclosure is not limited to the following embodiments.

### First Embodiment

### 1. Image Forming Apparatus

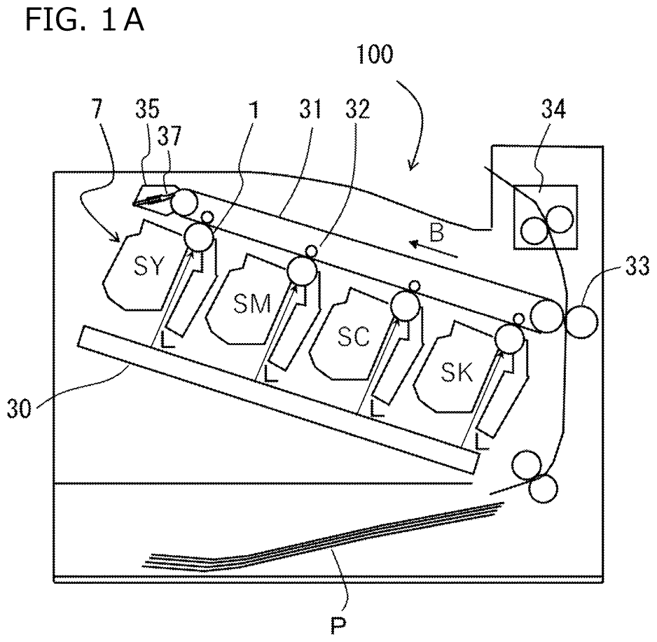

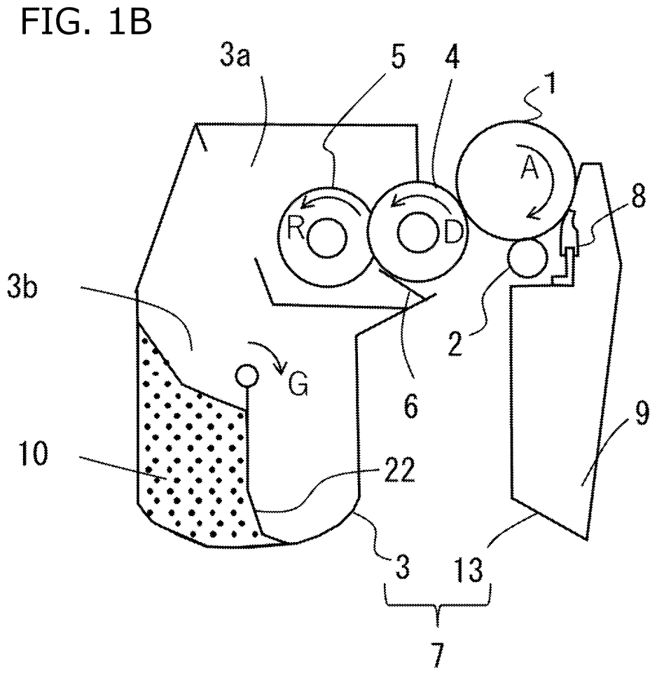

An overall configuration of an electrophotographic image forming apparatus according to the present embodiment will be described. FIG. 1A is a schematic sectional view of an image forming apparatus 100 of the present embodiment, and FIG. 1B is a sectional view of a process cartridge 7 of the present embodiment as viewed along a longitudinal direction (rotation axis direction) of a photosensitive drum 1. The image forming apparatus 100 of the present embodiment is a full-color laser printer adopting an in-line method and an intermediate transfer method. The image forming apparatus 100 can form a full-color image on a recording material P (for example, recording paper, plastic sheet, cloth, and the like) according to image information. The image information is input to the image forming apparatus 100 from an image reading apparatus (not illustrated) connected to the image forming apparatus 100 or a host device (not illustrated) such as a personal computer communicably connected to the image forming apparatus 100.

The image forming apparatus 100 includes, as a plurality of image forming units, first, second, third, and fourth image forming units SY, SM, SC, and SK for forming images of respective colors of yellow (Y), magenta (M), cyan (C), and black (K), respectively. Hereinafter, subscripts Y, M, C, and K for distinguishing colors are attached to reference numerals of members contributing to formation of toner images of respective colors, but the subscripts Y, M, C, and K may be omitted except when describing a specific color. In the present embodiment, the image forming apparatus 100 includes, as a plurality of image carriers, photosensitive drums 1 that are four drum-type electrophotographic photoreceptors provided side by side in a direction intersecting a vertical direction. The photosensitive drum 1 is integrated with the image forming unit S to form the process cartridge 7.

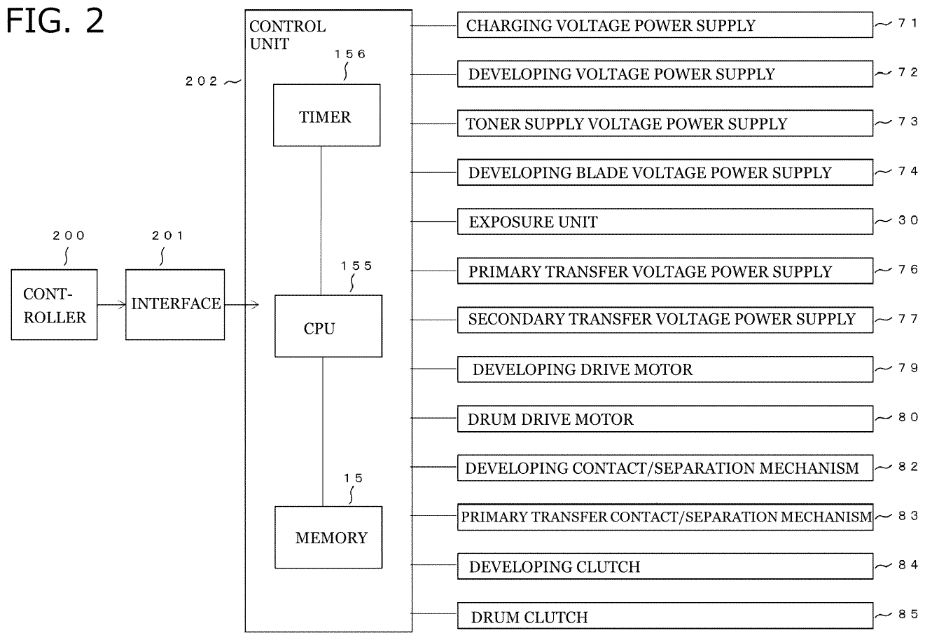

The rotatable photosensitive drum 1 which is an image carrier that carries an electrostatic latent image is rotationally driven in a direction of an arrow A by a drum drive motor 80 (refer to FIG. 2) which is a drive unit. A charging roller 2, which is a charging member, is a single-layer roller including a conductive core metal and a conductive rubber layer, and has, for example, an outer diameter φ7.5 mm and a volume resistivity of 10³ to 10⁶ Ω·cm. Then, a DC voltage expressed as Vd+Vth is applied to the charging roller 2 by a charging voltage power supply 71 (refer to FIG. 2), and a surface of the photosensitive drum 1 is uniformly charged at the charging potential Vd by discharge. The charging potential Vd at this time is, for example, −500 V. Vth is a discharge starting voltage, and when the charging voltage to be applied is small, a surface potential on the photosensitive drum 1 does not increase due to discharge, but the surface potential starts to increase due to discharge from the discharge starting voltage Vth. That is, the discharge starting voltage Vth in the present embodiment is −500 V.

After the surface of the photosensitive drum 1 is charged by the charging roller 2, the surface of the photosensitive drum 1 is irradiated with laser light (arrow L) from an exposure unit 30. The exposure unit 30 is an exposure means that emits laser light L based on the image information to form an electrostatic latent image on the surface of the photosensitive drum 1. The surface potential of the surface of the photosensitive drum 1 irradiated with the laser light L changes to, for example, −100 V as Vl, which is an exposure potential, and an electrostatic latent image is formed.

The process cartridge 7 includes a developing unit 3 and a photosensitive drum unit 13. In the developing unit 3, a developing roller 4 which is a developer carrier and a toner supply roller 5 which is a toner supply member are disposed. The developing unit 3 is provided with a developing chamber 3a, a toner storage 3b, a developing blade 6, and a toner conveying member 22 for conveying the toner 10 as a developer to the developing chamber 3a by rotating in a direction of an arrow G. When receiving a driving force of the developing drive motor 79 (refer to FIG. 2), the developing roller 4 starts to rotate in a direction of an arrow D, and the toner supply roller 5 starts to rotate in a direction of an arrow R. Then, a developing voltage is applied from a developing voltage power supply 72 (refer to FIG. 2) to the developing roller 4. As a result, the toner 10 is supplied to the electrostatic latent image formed on the surface of the photosensitive drum 1, that is, the portion of the exposure potential Vl described above by the developing roller 4 and is developed. Note that a developing clutch 84 (refer to FIG. 2) for transmitting or interrupting the driving force of the developing drive motor 79 is provided, and a driving timing of the developing unit of each color can be changed.

The developer image (toner image) developed on the surface of the photosensitive drum 1 is transferred to an intermediate transfer belt 31 which is an intermediate transfer member illustrated in FIG. 1A. The intermediate transfer belt 31, which is an endless belt serving as an intermediate transfer member, is a member for facing the photosensitive drum 1 of each image forming unit S and transfers the toner image on the photosensitive drum 1 to the recording material P. The intermediate transfer belt 31 is brought into contact with the photosensitive drum 1 of each image forming unit S and circulates (rotates) in a direction of an arrow B (counterclockwise direction).

A primary transfer roller 32, which is a transfer member as a primary transfer unit, is disposed on the inner peripheral surface side of the intermediate transfer belt 31 so as to face each photosensitive drum 1. Then, a voltage having a polarity opposite to the regular charging polarity of the toner is applied to the primary transfer roller 32 from a primary transfer voltage power supply 76 (refer to FIG. 2). As a result, the toner image on the photosensitive drum 1 is transferred (primarily transferred) onto the intermediate transfer belt 31. In the present embodiment, the regular polarity of the toner is set to negative polarity. Therefore, the primary transfer can be performed by applying a positive voltage as a primary transfer voltage (transfer voltage). The intermediate transfer belt 31 and the primary transfer roller 32 can be brought into contact with the photosensitive drum 1 or separated from the photosensitive drum 1 via a primary transfer contact/separation mechanism 83 (refer to FIG. 2). In the present embodiment, both the photosensitive drum 1 and the intermediate transfer belt 31 are driven by the drum drive motor 80, and ON/OFF of driving of each of the photosensitive drum 1 and the intermediate transfer belt 31 can be switched by a drum clutch 85 (refer to FIG. 2).

A secondary transfer roller 33 as a secondary transfer unit is disposed on the outer peripheral surface side of the intermediate transfer belt 31. Then, a voltage having a polarity opposite to the polarity of the toner is applied to the secondary transfer roller 33 from a secondary transfer voltage power supply 77 (refer to FIG. 2) as a secondary transfer voltage application unit. As a result, the toner image on the intermediate transfer belt 31 is transferred (secondarily transferred) onto the recording material P. Hereinafter, a position where the toner image is secondarily transferred to the recording material P is referred to as a secondary transfer portion. For example, at the time of forming a full-color image, the above-described process is sequentially performed in the image forming units SY, SM, SC, and SK, and the toner images of the respective colors are sequentially superimposed and primarily transferred onto the intermediate transfer belt 31. Thereafter, the recording material P is conveyed to the secondary transfer unit in synchronization with the movement of the intermediate transfer belt 31. Then, the four color toner images on the intermediate transfer belt 31 are secondarily transferred collectively onto the recording material P by the action of the secondary transfer roller 33 in contact with the intermediate transfer belt 31 via the recording material P. The recording material P to which the unfixed toner image has been transferred is conveyed to a fixing device 34. By applying heat and pressure to the recording material P in the fixing device 34, the toner image is fixed to the recording material P, and the recording material P is discharged to the outside of the image forming apparatus 100.

Further, the toner remaining on the surface of the photosensitive drum 1 without being transferred by the primary transfer roller 32 is scraped off from the surface of the photosensitive drum 1 by the cleaning blade 8 which is a cleaning member in contact with the photosensitive drum 1. The toner scraped off by the cleaning blade 8 is stored in a waste toner storage chamber 9 provided below the cleaning blade 8. The toner which is not transferred to the recording material P by the secondary transfer roller 33 and remains on the intermediate transfer belt 31 is conveyed to a cleaning device 35 for the intermediate transfer belt 31 as a cleaning device, and is stored in a waste toner storage container (not illustrated). The cleaning blade 37 includes a galvanized steel plate having a longitudinal length of 240 mm and a thickness of 3 mm, and a urethane rubber blade attached to the steel plate. The urethane rubber blade has a longitudinal length of 230 mm, a thickness of 2 mm, and a hardness of 77 degrees in accordance with JIS K 6253 standard. The cleaning blade 37 is pressed against a tension roller via the intermediate transfer belt 31 in the counter direction with a linear pressure of 0.49 N/cm and a total pressure (overall pressure) of about 11.3 N. A control unit 202 will be described later.

### 2. Schematic Configuration of Process Cartridge

An overall configuration of the process cartridge 7 attached to the image forming apparatus 100 of the present embodiment will be described in detail with reference to FIG. 1B. The process cartridge 7 is attachable to and detachable from the image forming apparatus 100 via an attachment unit such as an attachment guide (not illustrated) and a positioning member (not illustrated) provided in the image forming apparatus 100. In other words, the photosensitive drum 1 can be inserted into and removed from the image forming apparatus 100. In the present embodiment, the process cartridges 7 for the respective colors all have the same shape. In the process cartridge 7 for each color, toners 10 of respective colors of yellow (Y), magenta (M), cyan (C), and black (K) are stored. In the present embodiment, the process cartridge 7 will be described, but the developing unit 3 may be configured to include a developing cartridge that can be independently attached to and detached from the image forming apparatus 100. In the present embodiment, the configuration and operation of the process cartridge 7 for each color are substantially the same except for the type (color) of the stored toner 10.

The process cartridge 7 includes the developing unit 3 including the developing roller 4 and the like, and the photosensitive drum unit 13 including the photosensitive drum 1. In the present embodiment, the developing unit 3 and the photosensitive drum unit 13 are integrated to form the process cartridge 7, but the present disclosure is not limited thereto. For example, the developing cartridge and the photosensitive drum cartridge may be detachably attached to the image forming apparatus 100.

The developing unit 3 is roughly divided into the developing chamber 3a and the toner storage 3b. The toner storage 3b is provided with the toner conveying member 22 for conveying the toner 10 to the developing chamber 3a. The toner conveying member 22 conveys the toner 10 to the developing chamber 3a by rotating in a direction of an arrow G in the drawing. The developing chamber 3a is provided with the developing roller 4 as a developer carrier that contacts with the photosensitive drum 1 and rotates in a direction of an arrow D in the drawing. In the present embodiment, the developing roller 4 and the photosensitive drum 1 rotate such that respective surfaces thereof move in the same direction at an opposing developing portion. The toner supply roller 5 and the developing blade 6 are disposed inside the developing chamber 3a. The toner supply roller 5 supplies the toner 10 conveyed from the toner storage 3b to the developing roller 4. The developing blade 6 is a toner regulating member that regulates a coating amount of the toner 10 on the developing roller 4 supplied by the toner supply roller 5 and performs charge application.

Respective independent voltages from power supplies are applied to the developing roller 4, the toner supply roller 5, and the developing blade 6 (refer to FIG. 2). The toner 10 supplied to the developing roller 4 by the toner supply roller 5 is charged by rubbing between the developing roller 4 and the developing blade 6, and is charged and the layer thickness is regulated. The toner 10 on the regulated developing roller 4 is conveyed to a portion facing the photosensitive drum 1 by the rotation of the developing roller 4 so as to develop and visualize the electrostatic latent image on the photosensitive drum 1 as a toner image.

At the time of the image forming operation, a predetermined DC voltage (developing voltage: Vdc) applied to the developing roller 4 is set to −300 V. By applying a voltage (toner supply voltage: Vr=−450 V) to the toner supply roller 5, a potential difference (ΔVr) between the toner supply roller 5 and the developing roller 4 is adjusted, and a supply amount of the toner 10 to the developing roller 4 is adjusted. In the present embodiment, ΔVr=Vdc−Vr is set to +150 V (=−300 V−(−450 V)), and the potential is set such that the toner having negative chargeability easily moves from the toner supply roller 5 to the developing roller 4.

The photosensitive drum 1 is rotatably attached to the photosensitive drum unit 13 via a bearing (not illustrated). The photosensitive drum 1 is rotationally driven in a direction of an arrow A in FIG. 1B by receiving the driving force of the drum drive motor 80. In the photosensitive drum unit 13, the charging roller 2 and the cleaning blade 8 as a plate-shaped elastic body are disposed so as to be in contact with the peripheral surface of the photosensitive drum 1. One end of the cleaning blade 8 is fixed to the plate-shaped metal sheet, and the other free end abuts against the photosensitive drum 1 in a counter direction with respect to the rotation of the photosensitive drum 1 to form a cleaning nip portion that is a contact portion between the cleaning blade 8 and the photosensitive drum 1. The surface of the photosensitive drum 1 is rubbed by the cleaning blade 8, and the toner 10 and fine particles remaining after the transfer step are scraped off and stored in the waste toner storage chamber 9. This prevents contamination of the charging roller 2 and image defects caused by the toner 10 being carried around with the rotation of the photosensitive drum 1.

### 3. Control Mode of Image Forming Apparatus

Next, a control mode of the present image forming apparatus will be described. FIG. 2 is a block diagram illustrating a schematic control mode of a main part of the image forming apparatus 100 according to the present embodiment. The control unit 202 is a controller that controls an operation of the image forming apparatus 100, and transmits and receives various electrical information signals. In addition, the control unit 202 processes electrical information signals input from various processing devices and sensors, and processes command signals to various process devices. A controller 200 exchanges various kinds of electrical information with a host device (not illustrated), and integrally controls an image forming operation of the image forming apparatus 100 by the control unit 202 via an interface 201 according to a predetermined control program or a reference table. The control unit 202 includes a CPU 155 as a central element that performs various arithmetic processing, a memory 15 such as a RAM or a ROM as a storage element, a timer 156 that measures time, and the like. Detection results of sensor, a count result of a counter, a calculation result, and the like are stored in the RAM, and a control program, a data table obtained in advance by an experiment, and the like are stored in the ROM. The control target, sensor, counter, and the like in the image forming apparatus 100 are connected to the control unit 202.

The control unit 202 controls transmission and reception of various electrical information signals, drive timing of each unit, and the like to control a predetermined image forming sequence, and the like. For example, the following high-voltage power supplies and devices are controlled in order to form a toner image on the surface of the photosensitive drum 1. The control unit 202 controls the charging voltage power supply 71 that applies a charging voltage, the developing voltage power supply 72 that applies a developing voltage, and a toner supply voltage power supply 73 that applies a toner supply voltage to the toner supply roller 5. In addition, the control unit 202 controls a developing blade voltage power supply 74 which is a power supply of the developing blade 6 which is a toner regulating member. Furthermore, the control unit 202 controls the exposure unit 30 and the like. Further, the control unit 202 controls the primary transfer voltage power supply 76, the secondary transfer voltage power supply 77, and the like for forming a toner image on the recording material P. In addition, the control unit 202 controls the developing drive motor 79 that drives the developing unit 3 and the drum drive motor 80 that drives the intermediate transfer belt 31 and the photosensitive drum 1. In addition, the control unit 202 controls the developing clutch 84 for transmitting or blocking the driving force of the developing drive motor 79 to the developing unit 3 and the drum clutch 85 for transmitting or blocking the driving force of the drum drive motor 80 to the photosensitive drum 1. In addition, the control unit 202 controls the developing contact/separation mechanism 82 that adjusts the contact and separation between the developing roller 4 and the photosensitive drum 1, and the primary transfer contact/separation mechanism 83 that adjusts the contact and separation between the photosensitive drum 1 and the intermediate transfer belt.

### 4. Configuration of Photosensitive Drum

The photosensitive drum 1 includes a cylindrical metal support having conductivity, a conductive layer as an undercoat layer of the support, a photosensitive layer (charge generation layer, charge transport layer) formed on the undercoat layer, and a protective layer formed on the photosensitive layer. The photosensitive drum 1 is formed by providing a photosensitive material such as OPC (organic photosemiconductor), amorphous selenium, or amorphous silicon on a drum base of a cylinder as a support having an outer diameter φ24 mm formed of aluminum, nickel, or the like. Furthermore, in the photosensitive drum 1 according to the present embodiment, a protective layer having abrasion resistance is provided on the outermost layer in order to improve abrasion resistance. By providing the protective layer, durability can be improved.

The protective layer preferably contains conductive particles and/or a charge transport material, and a resin. Examples of the conductive particles include particles of metal oxides such as titanium oxide, zinc oxide, tin oxide, and indium oxide. Examples of the charge transport material include a polycyclic aromatic compound, a heterocyclic compound, a hydrazone compound, a styryl compound, an enamine compound, a benzidine compound, a triarylamine compound, and a resin having a group derived from these materials. Among them, a triarylamine compound and a benzidine compound are preferable. Examples of the resin include a polyester resin, an acrylic resin, a phenoxy resin, a polycarbonate resin, a polystyrene resin, a phenol resin, a melamine resin, and an epoxy resin. Among them, a polycarbonate resin, a polyester resin, and an acrylic resin are preferable.

The protective layer may be formed as a cured film by polymerizing a composition containing a monomer having a polymerizable functional group. Examples of the reaction at that time include a thermal polymerization reaction, a photopolymerization reaction, and a radiation polymerization reaction. Examples of the polymerizable functional group of the monomer having a polymerizable functional group include an acrylic group and a methacrylic group. As the monomer having a polymerizable functional group, a material having charge transporting ability may be used.

The protective layer may contain additives such as an antioxidant, an ultraviolet absorber, a plasticizer, a leveling agent, a slipperiness imparting agent, and an abrasion resistance improver. Specific examples thereof include a hindered phenol compound, a hindered amine compound, a sulfur compound, a phosphorus compound, a benzophenone compound, a siloxane-modified resin, silicone oil, fluororesin particles, polystyrene resin particles, polyethylene resin particles, silica particles, alumina particles, and boron nitride particles. An average film thickness of the protective layer is preferably 0.5 μm or more and 10 μm or less, and preferably 1 μm or more and 7 μm or less.

The protective layer can be formed by preparing a coating liquid for a protective layer containing each of the above-described materials and a solvent, forming a coating film, and drying and/or curing the coating film. Examples of the solvent used in the coating liquid include an alcohol-based solvent, a ketone-based solvent, an ether-based solvent, a sulfoxide-based solvent, an ester-based solvent, and an aromatic hydrocarbon-based solvent. In the present embodiment, the average film thickness of the protective layer is 3 μm.

### 5. Surface Roughening Treatment of Photosensitive Drum

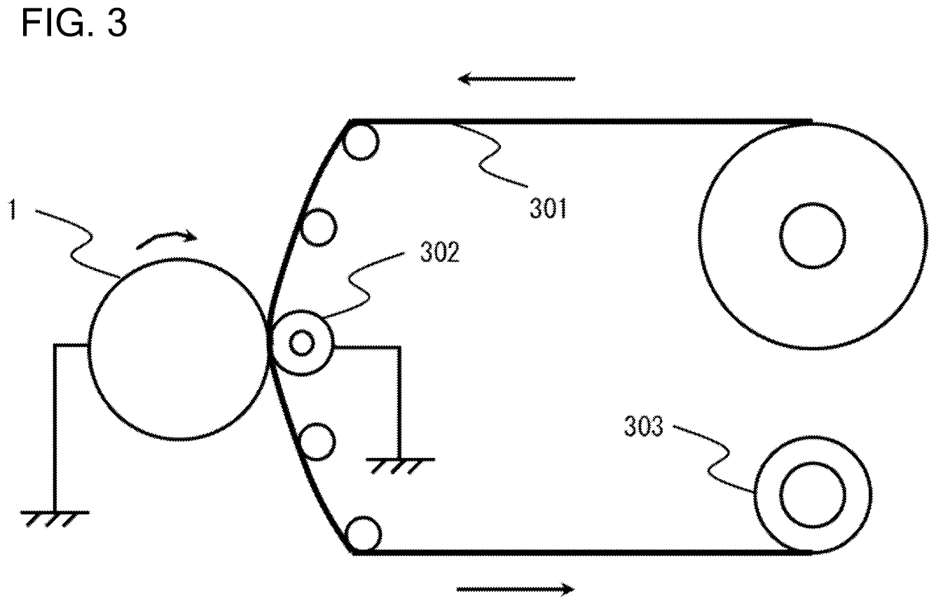

FIG. 3 is a schematic view of a polishing apparatus for polishing the surface of the photosensitive drum 1. In the present embodiment, the surface of the photosensitive drum 1 is polished using the polishing apparatus illustrated in FIG. 3 to perform a roughening treatment. By bringing a sheet-like polishing member (polishing sheet) 301 into pressure contact with the surface of the photosensitive drum 1 and relatively moving the surface and the polishing sheet, the surface of the photosensitive drum 1 was rubbed for a certain period of time to impart roughness thereto. Polishing conditions are shown below. Ra of the surface of the manufactured photosensitive drum 1 was as shown in Table 1.
Polishing sheet: Trade name: GC #8000 (manufactured by Mipox Corporation)
Polishing sheet feed speed: 250 mm/min
The number of rotations of photosensitive drum: 500 rpm
Polishing sheet penetration depth: 1.2 to 2.2 mm
Polishing time: 5 to 30 seconds

### 6. Method for Measuring Surface Roughness of Photosensitive Drum

The surface roughness Ra of the polished photosensitive drum 1 was measured under the following conditions using a surface roughness measuring instrument (Trade name: ET4000A, manufactured by Kosaka Laboratory Ltd.).
Cut-off value: 0.08 mm
Preliminary length: cut-off ×1
Filter characteristics: 2 CR
Evaluation length: 2.5 mm
Vertical magnification: 10,000
Lateral magnification: 50
Feed speed: 0.1 mm/sec
Leveling: Straight line (entire region)
JIS B 0601-1982
Process from total length of evaluation length: Interval evaluation length divided equally into 8,000
λs filter: None
Polarity: normal

Three regions were provided on the photosensitive drum in the long axis direction, the center of each region was measured at three points, and an average value was defined as Ra. Results are shown in the column of “Drum Roughness Ra” in Table 1.

### 7. Surface Shape and Surface Roughness Measurement Method of Intermediate Transfer Belt

In order to reduce friction at a contact portion between the photosensitive drum 1 and the intermediate transfer belt 31, a predetermined uneven shape (waviness) is formed on a surface (outer peripheral surface) of the intermediate transfer belt 31 in contact with the photosensitive drum 1.

In the curable composition that forms the basis of the surface layer, the electric charge of conductive metal oxide particles is negative, and a stable dispersion state is maintained. When the curable composition is dip-coated on a base layer, an alkali metal salt present in the base layer is dissolved by a solvent, and the alkali metal ion concentration in a surface layer film increases. Furthermore, as the volatilization of the solvent progresses, the alkali metal ion concentration in the surface layer film further increases. At that time, the alkali metal ions in the surface layer film coordinate with and adsorb onto the conductive metal oxide particles, the negative charges of the conductive metal oxide particles are lost, and aggregation of the conductive metal oxide particles occurs. By utilizing and controlling this property, a desired surface uneven shape (waviness) can be obtained.

The uneven shape (waviness) obtained by the aggregation action was measured using a scanning white interference microscope VS1550 (Hitachi High-Tech Corporation.). At four predetermined positions S1 to S4 in a circumferential direction of the intermediate transfer belt 31, measurement was performed at predetermined two locations in a width direction (Z2), that is, eight locations in total (S11, S12, S21, S22, S31, S32, S41, and S42). Then, an average value of measurement results at the eight points was defined as arithmetic average roughness Sa of the surface of the target intermediate transfer belt 31 in a predetermined region(S). In the present embodiment, the four phases S1 to S4 are equally set in the circumferential direction of the intermediate transfer belt 31. Further, in the width direction (Z2), the measurement points S11 and S12 are set at symmetrical positions with respect to a center position. Specifically, for example, in the present embodiment, as illustrated in the drawing, a length L1 of the intermediate transfer belt 31 between S1 and S2 is set to 178 mm, and a distance L2 between S11 and S12 is set to 180 mm. In addition, as a detailed setting of the scanning white interference microscope VS1550, measurement was performed on a predetermined region(S) of about 1100× 1100 μm in a Wave mode using a 10-fold magnification objective lens. Surface shape correction was performed on the obtained two-dimensional height information by a fourth-order polynomial, analysis was performed under the condition without cut-off, and the arithmetic average roughness (three-dimensional roughness) Sa of each field of view (predetermined region S) was calculated. The results are shown in the column of “Belt Roughness Sa” in Table 1.

### 8. Toner and External Additive

In the present embodiment, a substantially spherical nonmagnetic one-component toner having a particle size distribution centered on a weight average particle size of about 7 μm was used.

Further, hydrotalcite particles having a triboelectric charging property opposite in polarity to that of the toner particles are added to the surface of the toner particles. When the toner particles and the hydrotalcite particles are rubbed together, the toner particles are charged to negative polarity by a triboelectric charging action, whereas the hydrotalcite particles are charged to positive polarity which is opposite to the polarity of the toner particles. By the microcarrier-like action of the hydrotalcite particles, the toner particles can be uniformly charged to negative polarity. The content of hydrotalcite in the toner is preferably 0.05 wt % or more, more preferably 0.10 wt % or more, and still more preferably 0.15 wt % or more. On the other hand, the content is preferably 0.60 wt % or less, 0.50 wt % or less, 0.40 wt % or less, or 0.30 wt % or less. The numerical ranges can be optionally combined.

Furthermore, a metal soap is added to the toner particle surface for the purpose of reducing adhesion of discharge products or the like. When the drive torque is reduced, it is difficult for the cleaning blade 8 to remove the discharge product, and the friction coefficient of the photosensitive drum 1 may increase. Therefore, in the present embodiment, the metal soap is supplied to the surface of the photosensitive drum 1 to form a protective film, thereby suppressing an increase in the friction coefficient. As the metal soap, zinc stearate was added. The content of the metal soap in the toner is preferably 0.60 wt % or less, more preferably 0.50 wt % or less, still more preferably 0.40 wt % or less, and even more preferably 0.30 wt % or less. On the other hand, the content is preferably 0.05 wt % or more, 0.10 wt % or more, or 0.15 wt % or more. The numerical ranges can be optionally combined.

The external additive also serves as a cleaning aid for improving cleaning performance. A gap in the nip between the photosensitive drum 1 and the cleaning blade 8 is filled with an external additive to prevent the toner from slipping through. In the present embodiment, the content of hydrotalcite is 0.20 wt %, and the content of zinc stearate is 0.20 wt %.

### 9. Method for Measuring Drive Torque of Photosensitive Drum

The photosensitive drums 1 of Examples 1 to 3 and Comparative Examples 1 to 3 were attached to the photosensitive drum unit 13, and a setting angle θ of the cleaning blade 8 was set to 24° and a penetration depth & was set to 1.0 mm.

In a low-temperature and low-humidity (temperature: 15° C., humidity: 10%) environment, with the developing roller 4 in contact with the photosensitive drum 1, −1 kV was applied to the charging roller 2, −300 V was applied to the developing roller 4, and −400 V was applied to the toner supply roller 5 and the developing blade 6 while the photosensitive drum 1 was rotated at a surface speed of 320 mm/s, and the developing roller 4 was rotated at a surface speed of 285 mm/s. The drive torque of the photosensitive drum for 2 seconds after the lapse of 60 seconds from the start of rotation was measured.

### 10. Method for Measuring Drive Torque of Intermediate Transfer Belt

In order to measure the drive torque of the intermediate transfer belt 31, 500 horizontal line images having a print coverage of 1% were printed using A4 size GF-C081 (manufactured by Canon Inc.) in a low-temperature and low-humidity (temperature: 15° C., humidity: 10%) environment. Thereafter, a torque gauge was attached to a driving roller of the intermediate transfer belt unit, and the drive torque was measured.

The sum of the drive torque of the four photosensitive drums 1 and the drive torque of the intermediate transfer belt 31 measured above was set as a total torque, and evaluation was performed as follows.
A: Good low torque performance, 9.5 kgf·cm or less
B: Low-torque effect present, greater than 9.5 kgf·cm and equal to or less than 10.5 kgf·cm
C: No low torque effect, greater than 10.5 kgf·cm

Evaluations A and B were considered to indicate a low torque effect. Results are shown in the column of “Torque” in Table 1.

### 11. Main Points of Present Embodiment

In the present embodiment, in order to realize low torque, the drum roughness and the belt roughness are adjusted by the roughening treatment of the drum surface and the uneven shape of the intermediate transfer belt 31. In addition, in order to achieve both low torque and cleaning performance, a plurality of drum roughnesses are prepared, and the toner that has passed through the cleaning blade 37 of the intermediate transfer belt 31 is recovered in the image forming portion of the photosensitive drum 1 having the smallest roughness. Furthermore, by increasing the surface potential of the photosensitive drum 1 having the smallest roughness, the toner that has passed through is effectively recovered by the cleaning blade 8.

### 12. Verification of Effect of Present Embodiment

In order to verify the effect of the present embodiment, 10,000 horizontal line images having a print coverage of 1% were printed in an environment under a low-temperature and low-humidity condition (temperature: 15° C., humidity: 10%) with an interval of 3 seconds provided for every two image formations.

While the photosensitive drum 1 was rotated at a surface speed of 320 mm/s and the developing roller 4 at a surface speed of 285 mm/s, the photosensitive drum 1 was set to the surface potential shown in Table 1 “dark part potential”, and −300 V was applied to the developing roller 4, and −400 V was applied to the toner supply roller 5 and the developing blade 6. In the evaluation of the cleaning performance, the degree of contamination of the surface of the photoreceptor and the surface of the charging roller during printing and after 10,000 sheets of image formation was evaluated. The evaluation was performed as follows.
A: The surface of the photoreceptor and the surface of the charging roller are not contaminated in a visual inspection, and there is no influence on the image.
B: The surface of the photoreceptor and the surface of the charging roller show almost no contamination in a visual inspection, and there is no influence on the image.
C: The surface of the photoreceptor and the surface of the charging roller are contaminated in a visual inspection, and there is influence on the image.

An effect on the image is defined as the occurrence of streaks in a white image due to toner slip-through in the recording material conveyance direction. The results are shown in the column of “Cleaning” in Table 1. A and B having no influence on the image were regarded as having the effect of the disclosure. In Table 1, “CE1” to “CE4” means “Comparative Example 1” to “Comparative Example 4”. “Sa” means “Belt roughness Sa [μm]”.

TABLE 1

| | Sa | Drum roughness Ra [μm] | | | | Dark portion potential [−V] | | | | | |
|---|---|---|---|---|---|---|---|---|---|---|---|
| | [μm] | First | Second | Third | Fourth | First | Second | Third | Fourth | Torque | Cleaning |
| Example 1 | 0.15 | 0.006 | 0.006 | 0.006 | 0.001 | 550 | 550 | 550 | 600 | A | A |
| Example 2 | 0.03 | 0.006 | 0.006 | 0.006 | 0.003 | 550 | 550 | 550 | 600 | B | A |
| Example 3 | 0.2 | 0.006 | 0.006 | 0.006 | 0.003 | 550 | 550 | 550 | 600 | A | B |
| CE 1 | 0.2 | 0.006 | 0.006 | 0.006 | 0.006 | 550 | 550 | 550 | 550 | A | C |
| CE 2 | 0.03 | 0.003 | 0.003 | 0.003 | 0.003 | 550 | 550 | 550 | 550 | B | C |
| CE 3 | 0.3 | 0.006 | 0.006 | 0.006 | 0.003 | 550 | 550 | 550 | 600 | A | C |
| CE 4 | 0.01 | 0.006 | 0.006 | 0.006 | 0.003 | 550 | 550 | 550 | 600 | B | C |

In Examples 1 to 3, it was found that the torque was 10.5 kgf·cm or less, no streaks caused by toner slip-through occurred, and occurrence of a cleaning failure could be suppressed while low torque was realized. That is, since the belt roughness Sa is 0.03 to 0.20 μm and the drum roughness Ra is 0.001 to 0.006 μm, a contact area between the intermediate transfer belt 31 and the cleaning blade 37 and a contact area between the photosensitive drum 1 and the cleaning blade 8 are reduced, and the effect of low torque can be obtained.

In addition, by setting the drum surface potential of the fourth image forming unit having the small drum roughness to −600 V greater in absolute value than the drum surface potential (−550 V) of the first to third image forming units, the occurrence of the cleaning failure can be suppressed. The reason for this will be described. In the present embodiment, the contact area between the intermediate transfer belt 31 and the cleaning blade 37 is reduced in order to achieve low torque. At an early stage in the low-temperature and low-humidity environment, the toner remaining on the intermediate transfer belt 31 without being transferred to the recording material has a large charge amount, and the electrostatic adhesion force to the intermediate transfer belt 31 is large. Therefore, in Comparative Examples 1 and 2, a slight cleaning failure occurs by passing through the cleaning device 35.

On the other hand, in Examples 1 to 3, the toner that had passed through was recovered by reverse transfer in the fourth image forming unit, and thus there was no effect on the image. In order to perform primary transfer of the toner on the photosensitive drum 1 to the intermediate transfer belt 31, a voltage having a polarity opposite to the regular charging polarity of the toner is applied. However, as the potential difference increases, the toner that has passed through is charged to have a polarity opposite to the regular charging polarity by discharge. That is, the potential difference is larger in the fourth image forming unit than in the first to third image forming units, and the toner that has passed through the fourth image forming unit is likely to be charged in the opposite polarity. In addition, since the drum roughness of the fourth image forming unit is small and the cleaning performance is high, even if the toner that has passed through from the intermediate transfer belt 31 to the photosensitive drum 1 is reversely transferred to the photosensitive drum 1 simultaneously with the primary transfer to the intermediate transfer belt 31, the toner can be collected by the cleaning blade 8. In particular, in Examples 1 and 2, the contact area between the intermediate transfer belt 31 and the cleaning blade 37 was larger than that in Example 3, and thus, it was possible to reliably collect the toner by the fourth image forming unit. On the other hand, in Example 3, the toner could be collected, but since more toner slipped through than in Examples 1 and 2, the surface of the charging roller was extremely slightly contaminated, but there was no effect on the image. For the above reason, even if the toner slips from the cleaning device 35, there is no influence on the image.

In Comparative Example 3, since the belt roughness was as large as 0.3 μm, the amount of toner slipping through the cleaning device 35 increased, the toner could not be recovered by the fourth image forming unit, and a cleaning failure occurred. In Comparative Example 4, since the belt roughness was as small as 0.01 μm, the contact area with the cleaning blade 37 was large, and a cleaning failure occurred due to the toner slip-through initiated by blade chipping.

In the present embodiment, the toner that has passed through the image forming unit of Bk is collected. With this configuration, it is possible to collect the toner during image formation even in a mono mode in which only Bk is printed. In addition, in the present embodiment, the drum roughness of the fourth image forming unit is made small, and the drum surface potential is made larger than that of the first to third image forming units. However, the present disclosure is not limited to this, and the toner that has passed through may be recovered by any one of the first to third image forming units having a small drum roughness. In addition, in the present embodiment, the drum surface potential is increased during the image formation, but a sequence of collecting during the non-image formation instead of the image formation may be provided. In the present embodiment, the drum surface potential is set to −600 V in order to collect the toner that has passed through, but the present disclosure is not limited thereto, and any potential sufficient to collect the toner that has slipped through is acceptable.

As described above, according to the present embodiment, occurrence of cleaning failures can be suppressed by reducing the drive torque by controlling the belt roughness and the drum roughness and collecting the toner passing through the cleaning device 35 by the reverse transfer in the image forming unit having the small drum roughness.

### Second Embodiment

In the present embodiment, as one of the more effective cleaning methods, an optimal configuration for collecting by reverse transfer in the image forming unit of the photosensitive drum 1 not subjected to the drum surface roughening treatment will be described. The photosensitive drum 1 not subjected to the drum surface roughening treatment has a large contact area with the cleaning blade 8 and high cleaning performance. In the present embodiment, even in the case of the same belt roughness of 0.2 μm as in Example 3, the toner that has passed through can be effectively collected by the cleaning blade 8, and low torque performance can be maintained.

In the present embodiment, the intermediate transfer belt 31 and the photosensitive drum 1 shown in Table 2 are used. The drum roughness Ra of 0.0005 μm corresponds to the photosensitive drum 1 not subjected to the drum surface roughening treatment. Also in the present embodiment, the content of hydrotalcite is 0.20 wt %, and the content of zinc stearate is 0.20 wt %.

### 1. Verification of Effect of Present Embodiment

In order to verify the effect of the present embodiment, as in the first embodiment, 10,000 horizontal line images having a print coverage of 1% were printed in an environment under a low-temperature and low-humidity condition (temperature: 15° C., humidity: 10%) with an interval of 3 seconds provided for every two image formations. In Table 2, “CE 5” to “CE 7” means “Comparative Example 5” to “Comparative Example 7”. “Sa” means “Belt roughness Sa [μm]”.

TABLE 2

| | Sa | Drum roughness Ra [μm] | | | | Dark portion potential [−V] | | | | | |
|---|---|---|---|---|---|---|---|---|---|---|---|
| | [μm] | First | Second | Third | Fourth | First | Second | Third | Fourth | Torque | Cleaning |
| Example 4 | 0.2 | 0.006 | 0.005 | 0.006 | 0.0005 | 550 | 550 | 550 | 600 | A | A |
| Example 5 | 0.2 | 0.003 | 0.001 | 0.003 | 0.0005 | 550 | 550 | 550 | 600 | A | A |
| CE 5 | 0.2 | 0.0005 | 0.0005 | 0.0005 | 0.0005 | 550 | 550 | 550 | 600 | C | A |
| CE 6 | 0.2 | 0.0005 | 0.0005 | 0.0005 | 0.006 | 550 | 550 | 550 | 600 | B | C |
| CE 7 | 0.2 | 0.008 | 0.008 | 0.008 | 0.0005 | 550 | 550 | 550 | 600 | A | C |

In Examples 4 and 5, it was found that the torque was 9.5 kgf·cm or less, no streaks caused by toner slip-through occurred, and occurrence of a cleaning failure could be suppressed while low torque was realized. That is, since the belt roughness Sa is 0.03 to 0.20 μm and the drum roughness Ra is 0.0005 to 0.006 μm, a contact area between the intermediate transfer belt 31 and the cleaning blade 37 and a contact area between the photosensitive drum 1 and the cleaning blade 8 are reduced, and the effect of low torque can be obtained.

In Examples 4 and 5, the amount of toner that passes through was the same as in Example 3 at a belt roughness of 0.2 μm, but the roughness of the photosensitive drum 1 of the fourth image forming unit was as small as 0.0005 μm. Therefore, since the cleaning performance was higher than that of Example 3, even if the slipped-through toner was reversely transferred to the photosensitive drum 1, the toner could be reliably collected by the cleaning blade 8.

In Comparative Example 5, since the roughness of all the first to fourth photosensitive drums 1 was as small as 0.0005 μm, no cleaning failure occurred, but the drive torque increased.

In Comparative Example 6, the roughness of the photosensitive drum 1 of the fourth image forming unit was as large as 0.006 μm. Since the cleaning performance of the fourth image forming unit is low, the toner that has passed through cannot be recovered by the cleaning blade 8 even if the toner is reversely transferred to the photosensitive drum 1, and a cleaning failure occured. In Comparative Example 7, the photosensitive drum roughness of the first to third image forming units was as large as 0.008 μm. Since the contact area between the photosensitive drum 1 and the cleaning blade 8 was too small, cleaning failures occurred in yellow (Y), magenta (M), and cyan (C).

As described above, according to the present embodiment, while the drive torque is reduced by controlling the belt roughness and the drum roughness, it is possible to suppress the occurrence of the cleaning failure by reliably collecting toner with the image forming unit of the photosensitive drum 1 without drum surface roughening treatment.

### Third Embodiment

In the present embodiment, an optimal configuration of the external additive content will be described as one of methods for more effectively cleaning while ensuring developability. As described above, the external additive content also has a role of uniformly charging the toner particles to negative polarity like the hydrotalcite particles in addition to the role of the cleaning aid. In general, since the charge amount varies depending on the coloring agent of the toner, some toners tend to easily retain charge. Therefore, as the lifetime becomes longer, the toner charge amount increases, and the potential difference between the surface potential of the developing roller 4 and the surface potential of the photosensitive drum 1 decreases, so that fogging may occur. Therefore, in the present embodiment, a case where the external additive content of the black toner is smaller than that of yellow, magenta, and cyan (0.05/0.05 to 0.15/0.15) will be described.

In the present embodiment, the intermediate transfer belt 31, the photosensitive drum 1, and the external additives shown in Table 3 are used. The drum surface potential during the image formation is the same as those in the first and second embodiments, and the drum surface potential is −550 V for the first to third image forming units and −600 V for the fourth image forming unit.

### 1. Verification of Effect of Present Embodiment

In order to verify the effect of the present embodiment, as in the first and second embodiments, 20,000 horizontal line images having a print coverage of 1% were printed in an environment under a low-temperature and low-humidity condition (temperature: 15° C., humidity: 10%) with an interval of 3 seconds provided for every two image formations. In Table 3, “CE 8” means “Comparative Example 8”. “Sa” means “Belt roughness Sa”. “External additive amount [wt %]” relates to “Hydrotalcite/Zinc stearate”.

TABLE 3

| | Sa | Drum roughness Ra [μm] | | | | External additive amount [wt %] | | | | | |
|---|---|---|---|---|---|---|---|---|---|---|---|
| | [μm] | First | Second | Third | Fourth | First | Second | Third | Fourth | Torque | Cleaning |
| Example 6 | 0.2 | 0.006 | 0.006 | 0.006 | 0.0005 | 0.20/0.20 | 0.10/0.10 | 0.20/0.20 | 0.05/0.05 | A | ∘ |
| Example 7 | 0.2 | 0.006 | 0.006 | 0.006 | 0.001 | 0.20/0.20 | 0.30/0.30 | 0.20/0.20 | 0.10/0.10 | A | ∘ |
| Example 8 | 0.2 | 0.006 | 0.006 | 0.006 | 0.003 | 0.20/0.20 | 0.20/0.20 | 0.20/0.20 | 0.15/0.15 | A | ∘ |
| CE 8 | 0.2 | 0.006 | 0.006 | 0.006 | 0.0005 | 0.20/0.20 | 0.05/0.05 | 0.20/0.20 | 0.20/0.20 | A | x |

In Examples 6 to 8, it was found that the torque was 9.5 kgf·cm or less, no streaks caused by toner slip-through occurred, and occurrence of a cleaning failure could be suppressed while low torque was realized. That is, since the belt roughness Sa is 0.03 to 0.20 μm, the drum roughness Ra is 0.0005 to 0.006 μm, and hydrotalcite and zinc stearate are 0.10 to 0.30 wt %, both low torque and cleaning can be achieved.

That is, according to Examples 1 to 8, when the drum having the smallest roughness is 0.0005 μm or more and 0.003 μm or less, hydrotalcite and zinc stearate are 0.05 wt % or more, the other drums are 0.001 μm or more and 0.006 μm or less, and hydrotalcite and zinc stearate are 0.10 wt % or more, both low torque and cleaning can be achieved.

In Examples 6 to 8, the external additive content (hydrotalcite/zinc stearate=0.05 to 0.15/0.05 to 0.15 wt %) in the fourth image forming unit is smaller than those in the first and second embodiments. The external additive fills the gap in the nip between the photosensitive drum 1 and the cleaning blade 8 to prevent the toner from slipping through. When the external additive content was small, the cleaning became more difficult. However, in Examples 6 to 8, as the external additive content desreased, the drum roughness was reduced and the contact area was increased. Therefore, the cleaning performance was enhanced, and no cleaning failure occurred.

In Comparative Example 8, the toner that had passed through the fourth image forming unit could be collected. However, the external additive content (hydrotalcite/zinc stearate=0.05/0.05 wt %) in the second image forming unit is small, and the drum roughness was as large as 0.006 μm. Since the contact area between the photosensitive drum 1 and the cleaning blade 8 was too small, a cleaning failure occurred in magenta (M).

In the present embodiment, the toner that had passed through the fourth image forming unit is reliably collected by changing the drum roughness according to the external additive content, but the present disclosure is not limited thereto, and the toner that had passed through may be collected by changing the drum roughness according to the toner characteristics (for example, the particle diameter).

As described above, according to the present embodiment, the occurrence of cleaning failure can be suppressed while reducing the drive torque by controlling the belt roughness, the drum roughness, and the external additive content.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-033264, filed Mar. 3, 2025 which is hereby incorporated by reference herein in its entirety.

What is claimed is:

1. An image forming apparatus comprising:
a first image carrier;
a second image carrier;
an intermediate transfer belt that is an endless belt configured to be rotatable while coming into contact with the first image carrier and the second image carrier, wherein a first toner image on the first image carrier and a second toner image on the second image carrier are primarily transferred onto the intermediate transfer belt;
a secondary transfer member that forms a secondary transfer portion with the intermediate transfer belt in order to secondarily transfer the first toner image and the second toner image primarily transferred to the intermediate transfer belt to a transfer material;
a secondary cleaning member that is provided on a downstream side of the secondary transfer portion in a moving direction of the intermediate transfer belt, comes into contact with the intermediate transfer belt, and cleans toner remaining without being secondarily transferred to the transfer material; and
a primary cleaning member that comes into contact with the first image carrier and cleans residual toner after primary transfer,
wherein an average roughness of a surface of the first image carrier in contact with the intermediate transfer belt is smaller than an average roughness of a surface of the second image carrier in contact with the intermediate transfer belt, and
an absolute value of a dark portion potential of the first image carrier is larger than an absolute value of a dark portion potential of the second image carrier.

2. The image forming apparatus according to claim 1,
wherein toner of the second toner image that remains without being secondarily transferred to the transfer material is cleaned by the secondary cleaning member.

3. The image forming apparatus according to claim 1,
wherein the first image carrier has an average roughness Ra of 0.0005 μm or more and 0.003 μm or less, and the second image carrier has an average roughness Ra of 0.001 μm or more and 0.006 μm or less.

4. The image forming apparatus according to claim 1,
wherein an average roughness Sa of the intermediate transfer belt is 0.03 μm or more and 0.2 μm or less.

5. The image forming apparatus according to claim 1,
wherein a content of an external additive in the toner is 0.10 wt % or more and 0.30 wt % or less.

6. The image forming apparatus according to claim 1,
wherein the first image carrier and the second image carrier have a protective layer as an outermost layer.

7. The image forming apparatus according to claim 1,
wherein a particle diameter of the first toner used to form the first toner image or an amount of an external additive to be externally added is different from a particle diameter of the second toner used to form the second toner image or an amount of an external additive.
